(19) United States
(12) Patent Application Publication
(10) Pub. No.: US 2007/0215424 A1
(43) Pub. Date: Sep. 20, 2007

(54) Portable carrier with non-skid features

(76) Inventor: Dawn Hartzog Mittleman, Santa Rosa, CA (US)

Correspondence Address: MAIER & MAIER, PLLC, 1000 DUKE STREET, ALEXANDRIA, VA, 22314, US

(21) Appl. No.: 11/711,033

(22) Filed: Feb. 27, 2007

Related U.S. Application Data
(60) Provisional application No. 60/776,923, filed on Feb. 28, 2006.

(51) Int. Cl. A45C 5/14; B62B 1/00; A45C 13/00; A45C 13/30

(52) U.S. Cl. 190/18 A; 190/115; 280/655; 280/47.315

(57) ABSTRACT

A wheeled suitcase or similar carrier of a manually directed mobile type is provided with roller elements on its various, outer surfaces so as to engage against barriers or obstacles in a non-skid manner.

### CROSS REFERENCE TO RELATED APPLICATIONS

This application claims priority under 35 U.S.C. §119(e) of U.S. Provisional Application 60/776,923 filed Feb. 28, 2006 the entire contents of which are hereby incorporated by reference. The present invention is the subject matter of applicant's Disclosure Documents filed in the U.S. Patent and Trademark Office on Jul. 21, 2005, Jul. 28, 2005, and Dec. 27, 2005 and designated, respectively, as Document Disclosure Program Registration No. 582,345, No. 582,913, No. 592,159. All benefits of each said Disclosure Document are claimed under 35 U.S.C. §122; 37 C.F.R. §1.14, and MPEP section 1706 and are incorporated by reference in their entirety

### BACKGROUND

1. Field

The present invention relates to portable carriers such as luggage, crates, containers and the like, and more particularly to wheeled carriers equipped with non-skid features facilitating transport of such carriers over elevated obstacles such as stairs, walls or other barriers.

2. Description

Portable, wheeled carriers such as luggage and other similar containers generally for personal use have been widely used in recent years by travelers. Hand-towed carriers equipped with relatively small wheels have proven significantly convenient in lightening the load of travelers and others who must transport relatively heavy loads by pulling a container along a pathway while walking.

For example, Plath's U.S. Pat. No. 4,995,487 discloses a luggage assembly in the form of a suitcase having integrally connected thereto a laterally extendable handle at its upper end and a wheel assembly at its lower end is disclosed. The extendable handle and the wheels enabled the user to tilt the suitcase slightly from its upright position to a slightly canted position in which it is supported solely by its wheels, and to simply tow the suitcase along the floor or sidewalk. Thus, the small wheels bear almost all the weight. This, it is believed, is a basic patent for the suitcase marketed under the Trademark, Rollaboard® suitcase.

Plath's ('487) wheel assembly includes at least two wheels disposed on a bottom lateral face panel of the suitcase compartment. Wheels are journalled on rotational shafts mounted in a support plate. A retaining tab has an aperture through which the rotational shafts are inserted. Outer retainer tabs punched from the support plates are bent so as to contact and retain ends of the rotational shafts to retain the wheels in place. Plath's ('487) rotary wheels are thus oriented such that only a small amount of each wheel at any given time is located outside the interior compartment of the suitcase.

If a pathway along which a carrier such as a suitcase is to be towed remains clear, unobstructed and reasonably level, the user may progress without significant effort and without incurring damage to the suitcase. However, when an obstacle or barrier is encountered and is of such size as to hinder forward movement of the wheeled carrier, damage to the carrier may be incurred and increased user effort required. Examples of such obstacles are curbs, stairways, escalators, bus steps, auto trunk ledges, loading platforms and the like.

Increasingly strict security measures prevent persons traveling alone from parking their cars at airport terminal curbside check-in facilities. Consequently, travelers first must park offsite and often are required to board a motorized shuttle bus. Typically, such shuttle bus has tall steps which pose obstacles for those with wheeled luggage.

In such situations, the user may have the unwelcome task of having to manually lift the suitcase to overcome the obstacle or, as an equally unwelcome alternative, suffer consequential damage to the suitcase surface and/or its contents. This is particularly troublesome for a number of reasons.

First of all, women represent a rapidly growing percentage of luggage toting travelers. They, along with an aging boomer generation growing older increasingly are faced with the difficult task of repeatedly lifting suitcases to clear obstacles. Secondly, people are more frequently inclined to carry relatively delicate computer equipment (laptops, digital audio players, and the like) in their wheeled carry-on luggage. Banging and dragging the suitcase up steps and stairways and across obstacles can cause irreparable harm to such equipment as well as the suitcase itself.

Even in the above mentioned early version of the rolling-type or wheeled suitcase (Plath's U.S. Pat. No. 4,995,487, there were concerns expressed about damaging the suitcase when it is pulled over obstacles. The Plath ('487) patent disclosure displays a protective flange disposed on each of its two wheel wells. The flange is said to reduce damage to the exterior vertical face panels should the suitcase be dropped, dragged or pushed over. Further, the protective flange also allows for riding smoothly up over a curb without damage to the fabric or surface of the suitcase.

There have been other modest attempts to protect the surface of rolling suitcases from damage caused by dragging the suitcase over obstacles or up a stair case or escalator. For example, patentee Kuo, in U.S. Pat. No. 6,484,362, shows wheels mounted in a plastic housing which includes a kick plate mounted between the wheels. Still others have relied upon a redesign of the wheel assembly itself in order to address barriers or obstacles in the suitcase path.

For example, as seen in U.S. Pat. No. 6,357,765 to Heien, an obstacle-traversing wheel assembly is designed to roll easily without dragging over electrical cords, trash and debris. The assembly includes a primary wheel journalled on an axle which is attached to a load carrying frame. At least four independently rotatable secondary wheels are mounted around the circumference of the primary wheel at locations equidistant from each other and from the primary wheel axle.

All of the secondary wheels of Heien's assembly are of the same diameter. The secondary wheels are spaced apart on the primary wheel at a distance that is less than the diameter of a secondary wheel. Besides its use as wheel members on luggage, the wheel assembly may find use as the leading wheel of an in-line skate board, or for supporting any other load carrying module that is rolled across a debris-strewn surface.

In some instances, wheels are mounted on containers in such as way that they are slidably received in wheel wells on respective sides thereof. For example, in U.S. Pat. No. 6,520,514 Klegg shows wheels and supporting struts in both an extended position and a retracted position. When the container is to be moved, the wheels can be extended.

Still other concerns have been raised about the hazards of luggage carts tilting or falling as they are carried on airport terminal escalators. Eguchi et al, in U.S. Pat. No. 6,126,176, address such hazards by disclosing and illustrating a fall suppressing device provided in a cart for moving up and down an escalator.

There is a need for portable container mechanisms, particularly luggage and suitcase containers designed to be towed on wheels, that avoid (1) skidding and scuffing of suitcase or luggage surfaces as they are towed up and lowered down steps stairways or across barriers and the like, and (2) having to stop towing the suitcase and pick it up so as to carry the suitcase to the top or bottom of a stair or across some other barrier. While considerable efforts have been focused upon retractable handles and wheels, and surface guards to prevent scuffing and so forth, the prior art falls far short of successfully avoiding the scuffing and extra efforts in dragging suitcases over obstacles.

It is an object of the present invention to overcome such shortcomings and other limitations of the prior art, and to provide an easy-to-use, portable carrier with non-skid features that will both safeguard carrier surfaces from damage and eliminate the user's frequent requirement to lift and transport the carrier. Other objects of the present invention will be apparent to those of ordinary skill in the art having the benefit of this disclosure.

### SUMMARY

It is a principal object of the present invention to provide portable carriers such as wheeled suitcases and the like with rotating wheel assemblies on the backside and bottom thereof. Note that the terms “backside” or “bottomside,” in the context of a wheeled carrier, are meant to refer respectively to the carrier's leading face as it is typically towed on its wheels (opposite and generally parallel to a carrier frontside which usually includes the carrier's access lid), and the lower surface where the carrier's wheels are typically directed. Such carriers are uniquely provided with auxiliary roller elements positioned at least at said backside, and further alternatively included at said bottomside and other carrier sides as well.

Said auxiliary rollers, strategically positioned on the various surfaces of said carrier, and adjacent to the carrier wheels, serve to substantially lessen damaging friction between the carrier surface and obstacles encountered such as stairways, steps, escalators, ramps, platforms and the like. The auxiliary rollers further enable users to simply tow or drag a carrier up obstacle surfaces or across obstacle edges (as a platform rim or stair tread) and lower the carrier down and across the same obstacle edges.

With the friction substantially lessened, even virtually eliminated in some instances, towing effort is similarly lessened, and lifting efforts are all but eliminated. Further, since the rollers are strategically placed at what would have been damaging friction points, scuffing, scraping and tearing of carrier surface material is considerably lessened, as well.

It is a further principal object of the present invention to present the rollers in a variety of useable and useful forms or embodiments, all in keeping within the scope and range of the present invention as described and claimed herein. One embodiment of the present invention presents said rollers in the form of at least a first pair of substantially cylindrical roller elements each of which is positioned along a backside of said carrier, and extending generally along said backside to a point terminating adjacent one of said carrier wheels. Said first pair of roller elements may extend only to the wheels, or may be spaced in-board of the wheels (i.e., located more closely to a generally vertical centerline of the backside) and extend substantially to a carrier bottomside edge.

Further, this embodiment alternatively may include a second pair of substantially cylindrical roller elements each of which is positioned along a bottom side of said carrier so as to engage a floor or other stationary surface, and extending along said bottom side to a point terminating adjacent one of said carrier wheels. These bottom side roller elements also may be placed “inboard” of the wheels so as to have clearance to extend past the wheels to a bottom side edge.

Said substantially cylindrical roller elements, as above described, are journalled for rotation almost completely within recessed roller housings, with a portion thereof outside for reasons to be understood. A first, minor portion of each said substantially cylindrical roller element extends outwardly of said roller housing, and a second, major portion of each said cylindrical roller element is recessed therein.

Said substantially cylindrical roller elements further include non-skid surfaces. Such non-skid surfaces may, for example, include one or more spiral bands of non-skid rubber or synthetic material with high traction qualities. Such spiral bands may be separately applied to, or fabricated integrally with said substantially cylindrical roller element surfaces. The spiral bands also may exhibit mutually differing pitches to further facilitate their movement, for example bands on matching roller elements may have left and right pitch spirals, respectively.

In another embodiment still within the scope of the disclosed and claimed invention, the rollers may be presented as multiple roller elements journalled in at least a pair of roller element sets. Each of said sets includes roller elements journalled in parallel for free rotation and located primarily within a housing such that a relatively minor, first portion of each roller element set extends outwardly of said housing, and a major, second portion of each said roller element set resides within said recessed set housing.

Each said roller element set further includes an endless belt positioned therearound such that said belt encompasses all the parallel roller elements in each said set. Said belt is positioned so as to travel outwardly of said housing recess, across an outer area defined by the outwardly extended roller element set, and returning within said housing recess. Said belt may further include a relatively high traction surface such as undulated or ribbed features generally ascribed to tractor belt treads.

In still another embodiment clearly within the scope of the disclosed and claimed invention, said rollers are presented as at least one set of multiple roller elements journalled in parallel within a separate, wrap-around track element. Each track element is constructed so as to include roller spindle bearing journals and has a finite length with a first and a second end or terminus. Interconnecting the first and second end is an adjustable coupling device such as a quick release snap lock connector or other adjustable buckle arrangement. The track element must of course be of high strength and rigid enough to maintain roller elements against the rigors of travel. At the same time, the track element must be flexible enough to be wrapped closely around an outer carrier surface.

When applied around a carrier and coupled or buckled so as to form a continuous loop, the roller element journal track will be viewed as crossing four sides of said carrier, namely the topside, front side, backside and bottom side. The result, particularly when dual journal tracks are employed in parallel, is a substantially frictionless surface to address obstacles. The track elements may include roller elements throughout its length (except of course for a small space to accommodate a coupling device). On the other hand, the track elements may include roller elements journalled thereon at specific areas relative to a carrier. For example, roller elements may be positioned only on a portion of the track element that engages a carrier backside.

In each embodiment discussed hereabove, the underlying object is that a carrier so equipped will hold the capacity to address obstacles through the intermediary of said varied roller configurations as described, and can be (1) towed upwardly, (2) lowered downwardly or (3) directly pulled across such obstacles with minimal effort and friction.

To accommodate the various angular positions the carrier will assume when towed upwardly or lowered downwardly, it may be important to modify the typical towing handle construction. For example, while a number of equivalent solutions may be provided, it is proposed to incorporate a pivot-joint at an appropriate location along the retractable towing handle. Once extended from its retracted or stowed position (within the carrier), the modified handle would be capable of assuming angular positions or articulations to accommodate the varied angularity of the carrier relative to the user.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 shows one exemplary embodiment representing an orthogonal view depicting a backside surface of a carrier with journalled cylinder features.

FIG. 2 is an exemplary embodiment showing orthogonal view depicting a frontside surface of the carrier shown in FIG. 1.

FIG. 3 illustrates another exemplary embodiment showing an orthogonal lateral side view of the carrier shown in FIGS. 1 and 2.

FIG. 4 is an exemplary schematic of the carrier with journalled cylinder features being towed by a user (not shown) up a staircase;

FIG. 5 is an exemplary schematic of the carrier of FIG. 4 being towed along a flat surface.

FIG. 6 represents an exemplary orthogonal view depicting a backside surface of a carrier furnished with multiple rollers journalled in a pair of sets on which is positioned an endless belt;

FIG. 7 represents an exemplary orthogonal view of the front side of the carrier depicted in FIG. 6;

FIG. 8 is an exemplary orthogonally projected lateral side view of the carrier illustrated in FIG. 6 and showing the belt in place;

FIG. 9 is an exemplary schematic of the carrier with multiple rollers and endless belt feature being towed by a user (not shown) up a staircase;

FIG. 10 is an exemplary schematic of the carrier of FIG. 8 being towed along a flat surface.

FIG. 11 represents an exemplary orthogonal view depicting a backside surface of a carrier furnished with multiple rollers journalled in parallel on a pair of discrete tracks;

FIG. 12 represents an exemplary orthogonal view of the frontside of the carrier depicted in FIG. 11;

FIG. 12a is an exemplary perspective view of a detail of FIG. 12;

FIG. 13 is an exemplary orthogonally projected lateral side view of the carrier illustrated in FIG. 11;

FIG. 14 is an exemplary schematic of the carrier of FIG. 11 being towed by a user (not shown) up a staircase;

FIG. 15 is an exemplary schematic of the carrier of FIG. 11 being towed along a flat surface.

FIG. 16 is an exemplary schematic of the carrier being towed by a user (not shown) up a staircase.

FIG. 17 is an exemplary enlarged cross sectional view of the rolling assembly of the carrier and its configuration with the carrier frame.

FIG. 18 is a backside view of an exemplary embodiment of the carrier.

FIG. 19 is a front side view of an exemplary embodiment of the carrier.

FIG. 20 is a side view of an exemplary embodiment of the carrier.

FIG. 21 is another an exemplary embodiment of the carrier being towed by a user (not shown) up an obstacle.

FIG. 22 is an exemplary enlarged view of the rolling assembly of the carrier and portable carrier strap.

FIG. 23 is a back side view of yet another exemplary embodiment of the carrier with rolling assembly.

FIG. 24 is a back side view of another exemplary embodiment of the rolling assembly detached from the carrier.

FIG. 25 is a side view of an exemplary embodiment of the rolling assembly detached from the carrier.

FIG. 26 is an enlarged view of an exemplary embodiment of the roller assembly.

FIG. 27 is a back side view of another exemplary embodiment of the rolling assembly.

FIG. 28 is a side view of an exemplary embodiment of the rolling assembly detached from the carrier.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

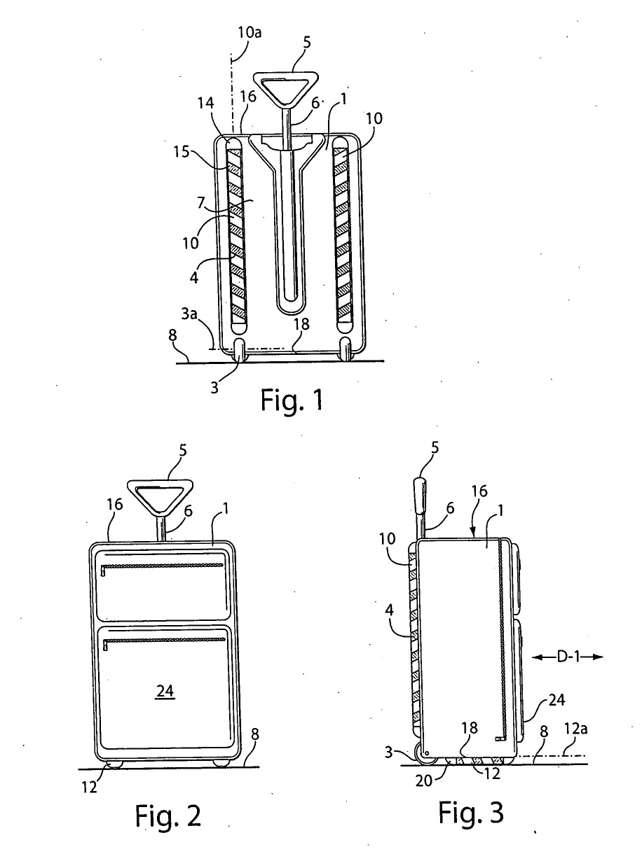

Illustrated in FIG. 1 is a carrier 1 with wheels 3 and handle 5. Wheel 3 is structurally positioned to rotate about an axis 3-a. Note that instead of a pair of wheels 3, as shown, a single elongated wheel could suffice. Further, more than a pair of wheels could be employed, for example two pair.

The carrier 1 may be a suitcase or other wheeled container designed to be towed and/or pushed as appropriate through the use of manual grip 6 on handle 5. Typically, as is well known, carrier 1 would be tilted or tipped so as to lean toward a user who then would walk while towing the carrier 1 behind, supported at least partially by said wheels 3 as they bear upon a floor 8 or other surface.

The carrier 1 surface as viewed in FIG. 1 may be described as the backside 7. When tilted, backside 7 normally leans toward the user and, consequently, toward a first direction of movement of the user when towing the carrier 1. In this instance, the backside 7 becomes the leading face of a traveling carrier 1. It also is well known that carrier 1 may on occasion be pushed (or permitted to move), rather than towed, in a second direction generally opposite to the first direction. Note bidirectional arrow at D-1 in FIG. 3.

Shown on backside 7 is a first set of roller elements 10 each of which is substantially cylindrical in shape and rotatably mounted in journals 14 affixed to said carrier 1 so as to support said roller elements primarily within recesses 15. Roller element 10 is shown structurally positioned so as to rotate about an axis 10-a. Roller elements 10 are mounted in said journals so as to be freely rotated when frictionally engaged by an external force. Each roller element 10 is shown as extending from a point adjacent a topside 16 of said carrier 1 to a point adjacent carrier 1 bottom side 18 where it is shown as terminating immediately adjacent a wheel 3. Alternatively, though not shown, the roller elements 10 may be spaced inboard of the wheels 3 so as to enable them to extend to a point adjacent an edge of bottom side 18.

Located along a bottom side 18 of carrier 1 (i.e., beneath the carrier 1 as shown in FIGS. 1-3) is a second set of roller elements 12, similar in form to roller elements 10. Each of the roller elements 12 is similarly mounted in journals 20 and extends from a point near a front side 24 of carrier 1 to a point adjacent bottom side 18 where it terminates immediately adjacent a wheel 3.

Again, though not shown, the roller elements 10 may be located inboard or outboard of the wheels 3 (e.g., between the wheels or outside the wheels closer to lateral extremities of backside 7) so as to enable them to extend to an edge of bottom side 18. Roller element 12 is structurally positioned so as to rotate about axis 12-a. This is more clearly illustrated in FIGS. 2 and 3.

The substantially cylindrical roller elements 10 and 12 are further provided with generally non-skid surfaces 4. Such non-skid surfaces 4 may, for example, include one or more spiral bands (as illustrated) of non-skid rubber or synthetic relatively high traction material affixed. Such spiral bands may be separately applied to, or integral with said substantially cylindrical roller element surfaces. As shown in FIG. 1, the spiral bands may have oppositely pitched bands.

Roller elements 10 and 12 are strategically aligned with respect to wheels 3 such that axes 10-a and 12-a generally lie in planes that are substantially perpendicular to wheel axis 3-a. Further, roller elements 10 and 12 are aligned with intended direction of movement D-1 (see FIG. 3) of carrier 1 as will be explained in more detail herebelow.

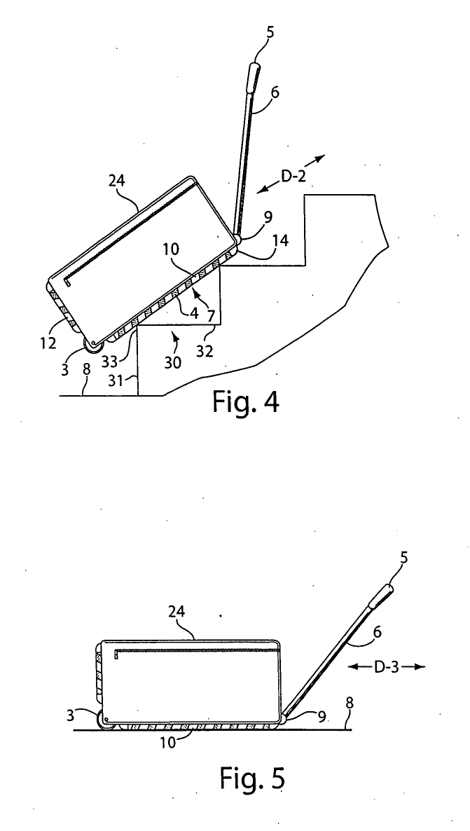

Illustrated in FIGS. 4 and 5 are two examples of unique movements of the carrier 1 that are facilitated by the present invention. When its leading face, namely 7, of carrier 1 is confronted with an obstacle, for example a barrier in the form of a stairway 30 rising from floor 8, the user may permit auxiliary roller elements 10 to confront a stair edge 33 defined by tread 32 and riser 31.

Handle 6, pivoted at 9, assumes a suitable angle to enable the user to tow carrier 1 up the stairway 30 facilitated by roller elements 10. The movement of roller elements 10 along the edges 33 will cause substantially non-skid surfaces 4 to rotate in their journals 14 and prevent damage to the carrier 1. By manually grasping grip 5 on handle 6, carrier 1 may thus be towed up stairway 30 or lowered down the stairway 30 by a user proceeding in optional directions indicated by bidirectional arrow D-2.

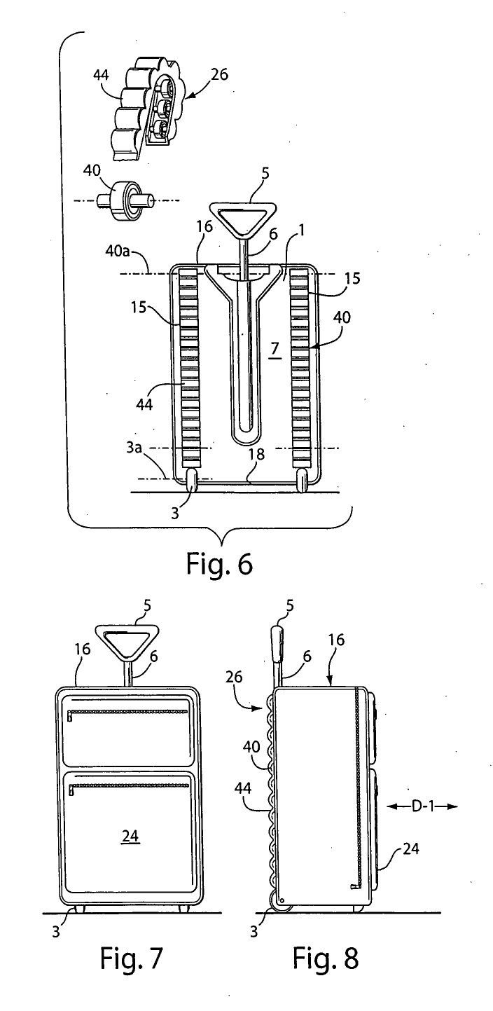

Illustrated in FIGS. 6-8 is another embodiment within the scope of the disclosed and claimed invention. Multiple, parallel roller elements 40 are shown as individually journalled for rotation within recess 15 such that a minor portion thereof extends outside the recess 15. The parallel roller elements 40 are shown in FIG. 6 as arranged in at least one set (two are illustrated), and further includes an endless belt 44 encompassing the set.

Belt 44 is configured and arranged to travel within recess 15 (behind or beneath the set) and to emerge outwardly, moving across an outer area defined by the outwardly extended roller element set and returning within the housing recess 15. This belt is supported on its inner surface for movement on the roller elements 40, and presents an outward, undulated or ribbed surface configuration that has high traction qualities. This configuration purposely evokes traction belts commonly seen on heavy road building equipment, such as Caterpillar® tractors. Of course, the belts of the present invention need only be durable enough to endure the rigors of travel and impact to carrier 1.

As in the previous embodiment, the roller element set illustrated in FIGS. 6-8 may be arranged adjacent one or more other sets (a pair is shown) and be positioned along a backside 7 of carrier 1. In the example shown in FIGS. 6-8, the pair of parallel roller element sets extends from points adjacent a topside 16 of carrier 1 to points adjacent carrier 1 bottom side 18 where extension of the pair of sets and its associated belt 44 terminates immediately adjacent wheel 3.

Alternatively, though not shown, the sets of roller elements 40 with the surrounding belts 44 may be spaced inboard of the wheels 3 so as to enable them to bypass wheels 3 and extend to a point adjacent an edge of bottom side 18. This arrangement will facilitate movement against and upward of stairways.

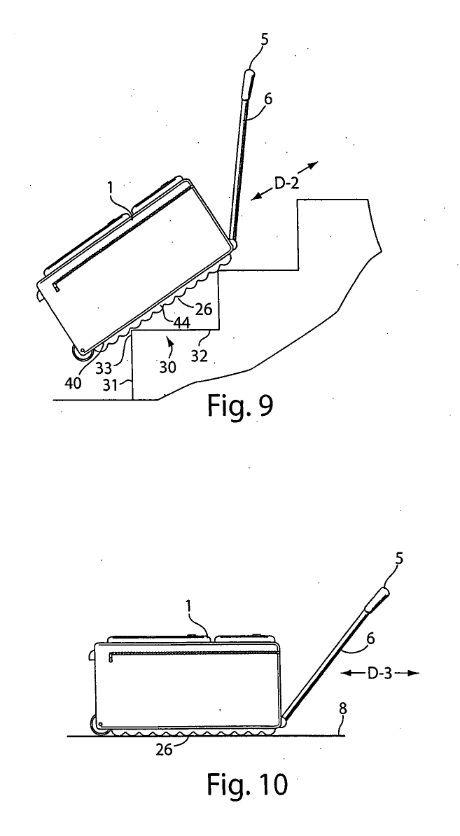

FIGS. 9 show an example where this embodiment can successfully address obstacles such as stairways 30. As in the previous embodiment, the carrier 1 may be pulled or towed upward (and lowered downward, as indicated by bidirectional arrow D-2) stairway 30 engaging edges 33 where tread 32 and riser 31 interconnect. The undulated or ribbed belt 44 engages edges 33 and facilitates easier transport of carrier 1 without surface damage thereto. Handle 6 is illustrated as articulated for pivotal movement to be more easily managed by user.

FIG. 10 illustrates how this embodiment can be used to transport carrier 1 on its backside 7 so as to move along a substantially flat surface 8 as indicated by bidirectional arrow D-3. When obstacles, curbs or other barriers are encountered, they are addressed and overcome by undulated or ribbed belt 44. Incidentally, belt 44 may be provided with friction surfaces other than the ribs or undulations. For example, an outwardly facing surface of belt 44 may be provided with a temporarily affixed, high surface friction material

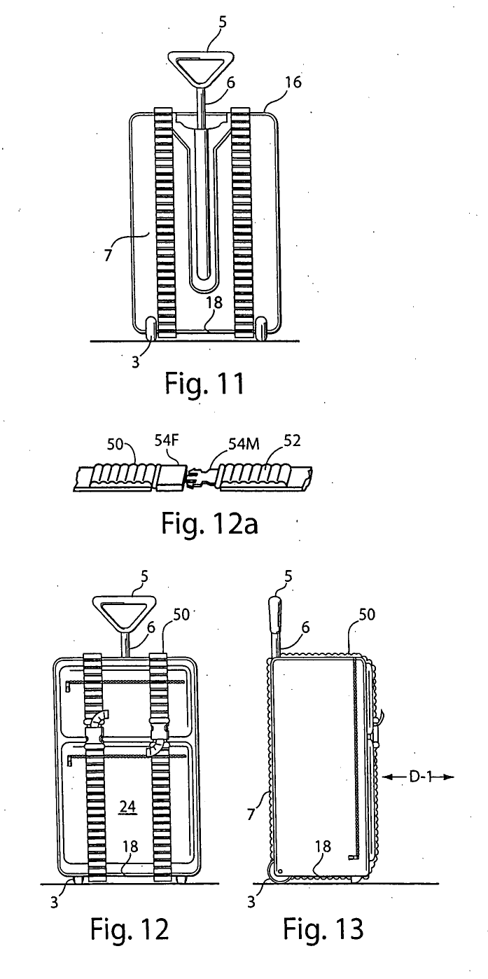

FIGS. 11-13 illustrate yet another embodiment considered well within the scope of the disclosed and claimed invention. In this embodiment, roller elements 52 are presented in separate, wrap-around roller tracks 50. The roller elements 52 are mounted in a mutually, substantially parallel array and journalled for independent rotation along tracks 50. At least one roller element track 50 (note that a pair is illustrated) is constructed so as to enable it to be wrapped about carrier 1.

Each track 50 is formulated of high strength material such as nylon webbing sized to surround a closed carrier 1. Track 50 also may be constructed of other flexible material such as plastic, leather, rubber and the like. With its multitude of roller elements 52, track 50 extends about suitcase 1 such that it wraps across topside 16, backside 7, bottomside 18 and frontside 24 where it is adjustably connected. As shown in FIGS. 12 and 12a, a fastener element 54 in the form of an adjustable, quick release snap fastener is provided for interconnecting the first and second ends of track 50. Of course, any suitable connector or fastener element 54 may be employed.

For purposes of illustration, the fastener element 54 may be of the interlocking type commercially available under the name UTX DURAFLEX® and WEINERLOCK®. At a first end of track 50 would be affixed a female clip 54F; at a second end, male clip 54M. In a well known manner, the track 50 is tightened or loosened by adjusting track 50 webbing with respect to clip fasteners 54. Such clip fastener 54 is illustrated in more detail in FIG. 12a. As points of reference, U.S. Pat. No. 5,240,106 issued to Plath and U.S. Pat. No. 4,883,207 issued to McArthur illustrate the common usage of adjustable, quick release clips for carriers. However, it again is noted that the scope of the present invention, while encompassing such features in the context of “adjustable connectors,” is in no way limited to such precise structure. Roller elements 52 may be journalled along the entire extent of track 50 (except for a relatively short segment reserved for clip fasteners 54); alternatively but not shown, roller elements 52 may be located on track 50 only at discrete locations so as to lie adjacent carrier 1 backside 7.

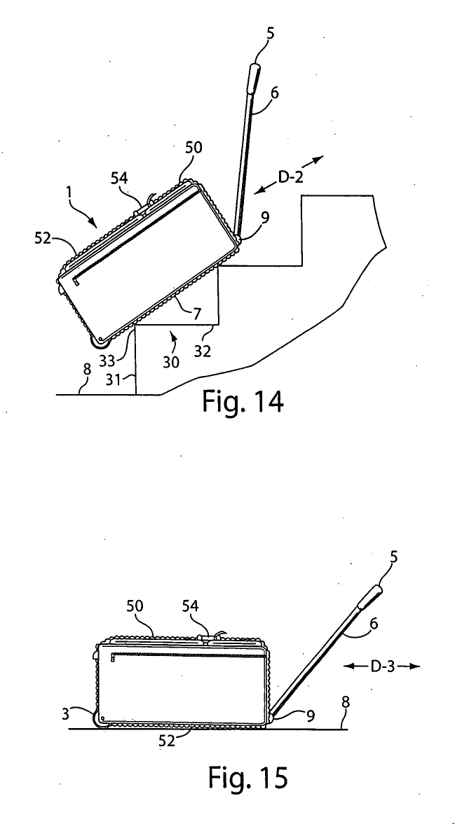

Carrier 1 may, of course, be moved bi-directionally as depicted at D-1 (FIG. 13) by movement on wheels 3. When meeting obstacles such as posed by staircase 30 exemplified in FIG. 14, the track 50 with rotatable roller elements 52 will address step edge 33 as discussed before as the user tows the carrier upward or lowers it downwardly as indicated by the bidirectional arrow D-2.

FIG. 15, as in other embodiments where roller elements are employed, shows the rollers 52 ready to engage floor 8 so as to advance as suggested by the bidirectional arrow D-3.

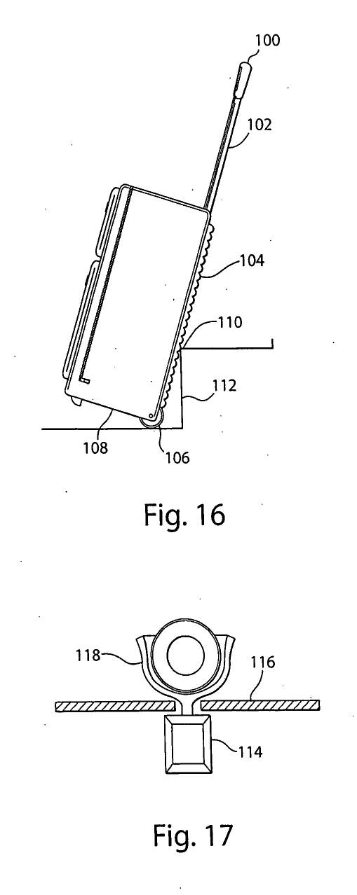

FIG. 16 and FIG. 17 illustrate yet another exemplary embodiment where a luggage container 108 with a handle grip 100 and connecting member 102 can make unique movements. When the leading face of carrier 108 is confronted with an obstacle, for example a barrier in the form of a stairway 112 rising from floor, the user may permit auxiliary roller elements 104 to confront a stair edge 110 defined by roller assembly 104.

Handle 100, assumes a suitable angle to enable the user to tow carrier 1 up the stairway 112 facilitated by roller elements 104. The movement of roller elements 104 along the edges 110 will cause substantially non-skid surfaces 4 to rotate in their journals 14 and prevent damage to the carrier 1. By manually grasping grip handle 100, carrier 100 may thus be towed up stairway 112 or lowered down the stairway 112 by a user proceeding in optional directions. Referring to FIG. 17 shows the exposed portion 118 of the wheel assembly near the exterior of the luggage carrier 116 and shows how the interior portion of the rolling assembly 114 fits over the luggage carrier frame 116.

Still referring to FIGS. 16-17 this portion of the rolling assembly 118 may allow attachment to the luggage during the manufacturing process. As shown the rolling assemblies may be partially encased which may help to protect the rolling assemblies during handling. The casing encloses the rolling assemblies on the side next to the luggage frame to allow continued free movement of the rolling assemblies. The exposed portion of the rolling assemblies may extend outside the luggage carrier and may come into contact with an obstacle for easy movement over the obstacle. Likewise, the rolling assemblies are designed to allow smooth transition to the bottom wheels as the assemblies move over and beyond obstacles. This smooth transition can reduce risk of injury and protect contents of the carrier from damage.

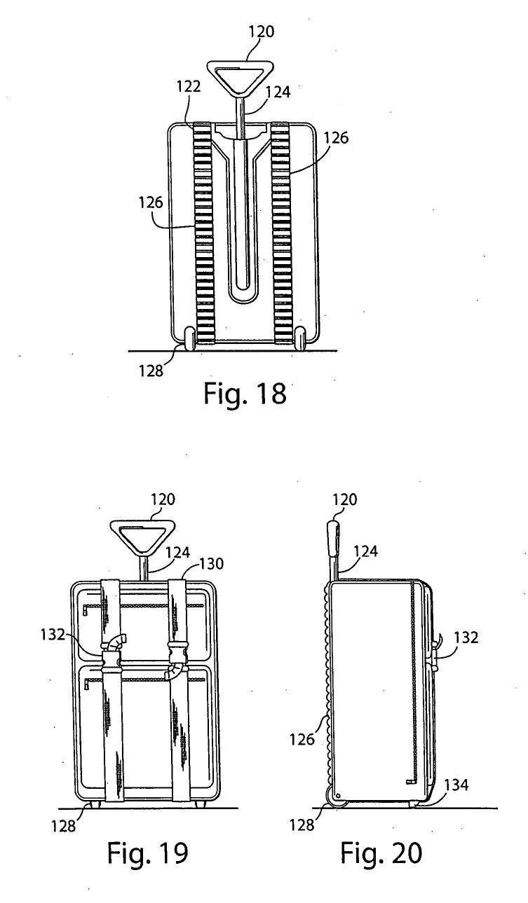

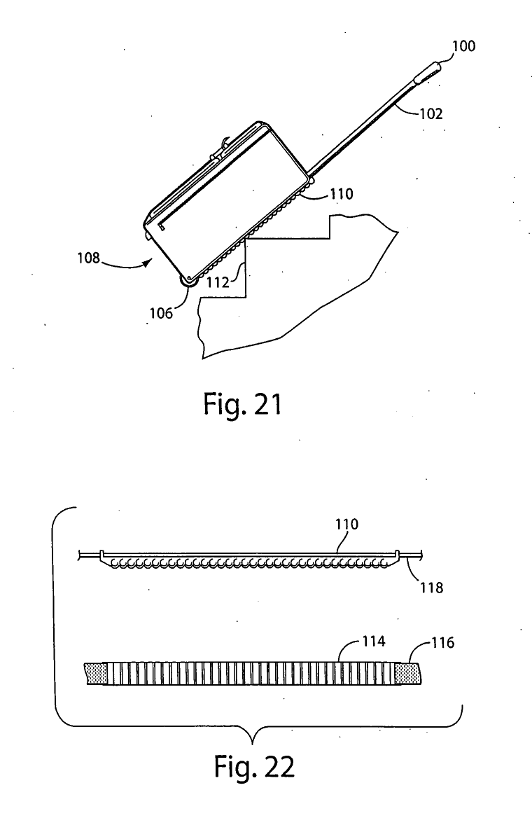

Illustrated in FIGS. 18-22 is another exemplary embodiment within the scope of the disclosed and claimed invention. A carrier with handle 120, connecting member 124, and wheels 128 is shown with multiple cylinder and/or ball assemblies 122, 126 in parallel assembly that may rotate both clockwise and counter clockwise so as to allow the carrier to move up and down obstacles.

Referring to FIG. 19 shows a strap design 130 with connecting member 132 which may be an connecting clip known to one having ordinary skill in the art. The strap design 130 may be configured in a parallel fashion as shown. The strap may be inserted through the assemblies which may ease the movement of the carrier as it glides over obstacles. Further the assemblies 126 may be partially encased in this exemplary embodiment to protect the cylinders and/or balls during handlings. The casing encloses the assemblies on the side next to the strap or luggage to allow continued free movement of the cylinder and/or balls. The exposed portion of the cylinder and/or ball may come into contact with an obstacle for easy movement over or past the obstacle.

Still referring to FIGS. 18-22 these assemblies may extend near existing wheels 128 to a sufficient height on the back of the carrier to allow ease of movement onto surfaces which may be higher than standard curbs and steps; such as shuttle buses and security inspection tables or other known steps commonly found in and around airports. Likewise, the rolling assemblies shown in the exemplary embodiment of FIGS. 18-22 are designed to allow smooth transition to the bottom wheels as the assemblies move over and beyond obstacles. This smooth transition can reduce risk of injury and protect contents of the carrier from damage.

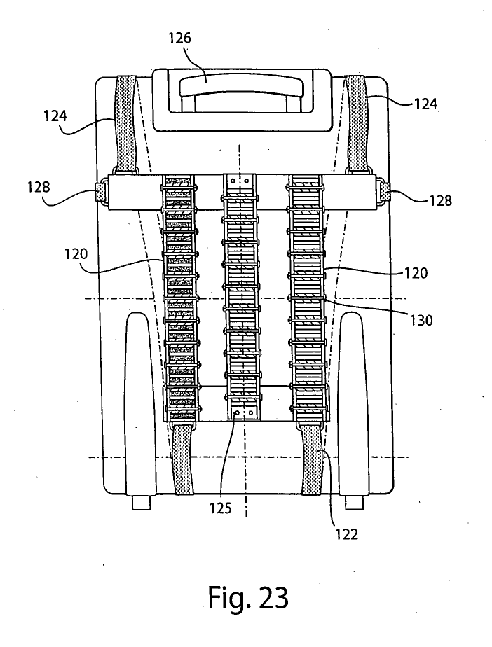

FIGS. 23-28 refer to yet another exemplary embodiment of the present invention. FIG. 23 shows a luggage carrier 126 with a plurality of straps 122, 124, and 128 configured to hold rolling assemblies 120 to a carrier. The straps, 122, 124 and 128 may optionally be adjustable and be made of any durable material known to one having ordinary skill in the art. The general dimensions of the rolling assemblies 120 and rolling units 130 with straps carrier may be about 16 inches wide at the aluminum end plates and about 14 inches from top to bottom as one non-limiting example. Likewise, the rolling units may be spaced apart at substantially equal intervals of about 1.25 inches. The aluminum end plates may be about ⅛ inch×2 inches×16 inches and include a plurality of slots of about 0.188 inches.

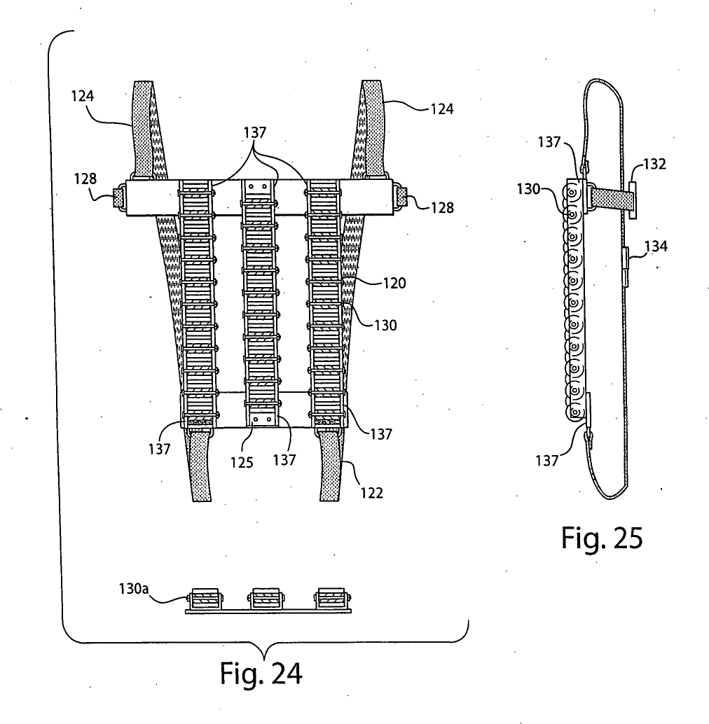

FIG. 25 shows a side view of the plurality of straps 122, 124, 128, which may have a clasp 134 and a National Transportation Safety Board (NTSB) locking clasp 132. Likewise, the rolling assemblies 120 and rolling units 130 may include a springs 137, 141 to act as a shock absorber and smooth the transition as the carrier moves over and past obstacles.

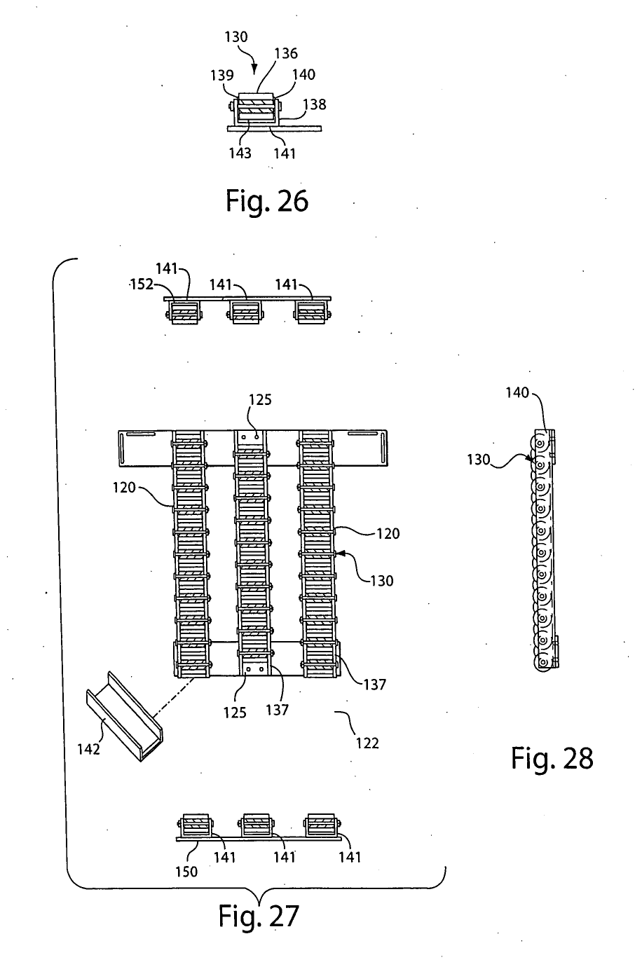

Referring to FIG. 26 the rolling assemblies 120 include a rolling unit 130 which may have an adapter tubing insert 140, nylon tubing 143, plastic washers 139, and an aluminum channel 138.

FIG. 27 shows the rolling assemblies 120 and rolling units 130 detached from a carrier. FIG. 27 also shows a plurality of substantially “U-shaped” slots which can be configured to hold the rolling assemblies 120 and rolling units 130. The rolling assemblies 120 and rolling units 130 may be attached to a substantially rigid aluminum plate at the top and bottom portions near the screws 125. Likewise, the top 152 and bottom 150 rolling unit may be configured to be attached to the carrier in this exemplary embodiment.

FIG. 28 shows a side view of the rolling assemblies 120 and rolling units 130 and may include springs 137, 141 to soften the ride when attached to a carrier.

Thus, the present invention delivers a long-awaited solution to the annoying, stressing and even injurious problems encountered by those who must contend with obstacles and barriers to the effective and efficient use of wheeled luggage and other similar mobile carriers. The strategic placement of roller elements at an outer perimeter of such carriers in the manner described and illustrated in a number of exemplary embodiments considerably lessen (1) the effort required to transport or transfer the carrier upward, downward and across barriers, and (2) the damage too often inflicted to a carrier surface and contents those encountered obstacles.

Each of the above-noted patent documents is, in its entirety, hereby incorporated by reference into this patent application. Upon careful review of the foregoing specification and drawings, it will be evident that the exemplary embodiments of the inventive article and system are susceptible of many modifications, combinations and alterations which may differ from those specifically set forth. The particular arrangements disclosed in the exemplary embodiments are meant to be illustrative only and not limiting as to the scope of the invention which is to be given the full breadth of claims now and subsequently presented thereto and any and all equivalents thereof.

What is claimed is:

1. A luggage roller assembly comprising:
a first and a second plate;
a plurality of substantially u-shaped members connecting the first and the second plate;
the plurality of substantially unshaped members hold a plurality of roller units connectable to a wall of the u-shaped member; and
a plurality of straps connected to the first and second plates configured to connect the luggage roller assembly to wheeled luggage.

2. The luggage roller assembly of claim 1, further comprising:
at least one clasp to connect the plurality of straps.

3. The luggage roller assembly of claim 1, further comprising:
a plurality of u-shaped loops extending from the first and the second plate.

4. The luggage roller assembly of claim 3, wherein
the plurality of u-shaped loops connect the first plate and the second plate with the plurality of straps.

5. The luggage roller assembly of claim 1, further comprising:
a plurality of substantially oval slots in the first and the second plate.

6. The luggage roller assembly of claim 5, wherein
the plurality of slots connect the first plate and the second plate with the plurality of straps.

7. The luggage roller assembly of claim 1 further comprising:
at least one clasp being a National Transportation Safety Board (NTSB) approved locking clasp.

8. The luggage roller assembly of claim 1 further comprising: at least one spring unit in close proximity to the plurality of u-shaped members.

9. The luggage roller assembly of claim 1 wherein the plurality of straps are configured adjustably fit a wheeled suitcase and luggage support that can be rolled aboard the passenger cabin of a commercial aircraft such that said wheeled suitcase and luggage support can be contained within the confines of the overhead compartment of said passenger cabin.

10. The luggage roller assembly of claim 1 further comprising:
a top plate and a bottom plate with a plurality of substantially u-shaped members holding a plurality of roller units connectable to a wall of the u-shaped member.

11. The luggage roller assembly of claim 11 further comprising:
at least one spring unit in close proximity to the plurality of u-shaped members.

12. A luggage roller system comprising:
a first and a second plate;
a plurality of substantially u-shaped members connecting the first and the second plate;
the plurality of substantially u-shaped members hold a plurality of roller units connectable to at least one wall of the u-shaped member;
a plurality of straps connected to the first and second plates configured to connect the luggage roller assembly to wheeled luggage; and
at least one lockable clasp configured to connect the luggage roller assembly to at least one of a wheeled suitcase or wheeled luggage.

13. The luggage roller system of claim 12, further comprising: at least one National Transportation and Safety Board (NTSB) approved locking clasp.

14. The luggage roller system of claim 12 wherein the roller units are connected to walls of the u-shaped members by a screw.

15.The luggage roller assembly of claim 12 further comprising:
at least one clasp being an National Transportation Safety Board (NTSB) approved locking clasp.

16.The luggage roller assembly of claim 12 further comprising: at least one spring unit in close proximity to the plurality of u-shaped members.

17. The luggage roller assembly of claim 12 wherein the plurality of straps are configured adjustably fit a wheeled suitcase and luggage support that can be rolled aboard the passenger cabin of a commercial aircraft such that said wheeled suitcase and luggage support can be contained within the confines of the overhead compartment of said passenger cabin.

18. A luggage roller system comprising:
a first and a second plate;
a plurality of substantially u-shaped members with means for spanning the first and the second plate;
the plurality of substantially u-shaped members hold a plurality of roller units connectable to at least one wall of the u-shaped member;
a plurality of straps with means for connecting to the first and second plates and means for securing the luggage roller system to wheeled luggage.

19. The luggage roller system of claim 18 further comprising at least one clasp with locking means.
